(19) United States
(12) Patent Application Publication
(10) Pub. No.: US 2001/0034415 A1
(43) Pub. Date: Oct. 25, 2001

(54) Impact-modified thermoplastic polymer mixtures based on SO2 copolymers having an aliphatic main chain

(76) Inventors: Joachim Queisser, Mannheim (DE); Peter Barghoorn, Kallstadt (DE); Graham Edmund Mc Kee, Neustadt (DE); Rolf Mulhaupt, Freiburg (DE); Rupert Schnell, Freiburg (DE)

Correspondence Address: Messrs. Keil & Weinkauf, 1101 Connecticut Ave., N.W., Washington, DC, 20036, US

(21) Appl. No.: 09/729,462

(22) Filed: Dec. 5, 2000

(30) Foreign Application Priority Data
Dec. 23, 1999 (DE) 19962841.6

(51) Int. Cl. C08L 33/14; C08L 33/00; C08L 31/00; C08L 35/02

(52) U.S. Cl. 525/212; 525/217; 525/220; 525/222

(57) ABSTRACT

Impact-modified thermoplastic polymer mixtures comprise copolymers (component A) formed from sulfur dioxide (a₁), from vinyl aromatic compounds (a₂), from unsaturated polar compounds (a₃₁) selected from the group consisting of compounds of the formula (I)

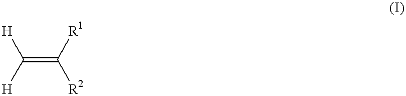

where R¹ is hydrogen or methyl and R² is CN, CHO or COOR³, where R³ is hydrogen or C₁-C₂₀-alkyl, and/or from cyclic olefins having non-conjungated double bonds (a₃₂) or from non-polar acyclic aliphatic olefins (a₃₃) and comprising at least one polymeric rubber compound with an elastomeric property profile (component B), and also, if desired, thermoplastic polymers (component C) and processing aids, colorants, stabilizers, antioxidants or reinforcing materials (component D).

The present invention relates to impact-modified thermoplastic polymer mixtures comprising copolymers (component A) formed from sulfur dioxide (a₁), from vinyl aromatic compounds (a₂), from unsaturated polar compounds (a₃₁) selected from the group consisting of compounds of the formula (I)

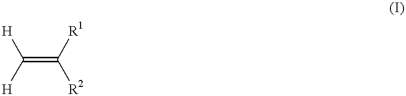

where R¹ is hydrogen or methyl and R² is CN, CHO or COOR³, where R³ is hydrogen or C₁-C₂₀-alkyl, and/or from cyclic olefins having non-conjungated double bonds (a₃₂) or from non-polar acyclic aliphatic olefins (a₃₃) and comprising at least one polymeric rubber compound with an elastomeric property profile (component B), and also, if desired, thermoplastic polymers (component C) and processing aids, colorants, stabilizers, antioxidants or reinforcing materials (component D).

The invention further relates to a process for preparing impact-modified thermoplastic polymer mixtures, and also to the use of these for producing films, fibers or moldings.

It is known that mixtures of various polymers can be prepared in order to obtain materials which combine the advantageous properties of the individual polymers, or in order to give access to materials with completely new properties. Experiments of this type have in particular also been directed at adding suitable polymers to compensate for disadvantageous properties of polymeric materials. The application of this concept in industry is often limited by immiscibility or poor compatibility of the polymers whose properties are intended to be complementary. In these cases compatibility can only be achieved, if at all, by adding promoters specifically tailored to the particular polymer mixture. These compatibilizers are mostly complicated to prepare and moreover can have a lasting effect on the desired property profile of the intended polymer mixture.

For example, suitable elastomeric components are added to polymeric materials which regularly have exposure to severe mechanical stresses but which in themselves are too brittle or stiff. However, due to problems of compatibility it is frequently possible to use only one particular rubber tailored to the polymeric material. Compromises in relation to the desired properties of the material then frequently have to be accepted in order to achieve appropriate compatibilization.

Polysulfones, i.e. polymers having regular incorporation of aromatic units, such as bisphenol A, into the main polymer chain, are known to the skilled worker as high-temperature thermoplastics. Polysulfones are compatible with only very few polymer materials. A known blend made from polysulfone and polytetrafluoroethylene has flowability better than that of polysulfones (see also L. A. Utracki, “Commercial Polymer Blends”, Chapman & Hall, 1998, London, p. 244). Polysulfones do not generally have good toughness or environmental stress tracking resistance, and are highly notch-sensitive. Since it is generally not possible to process these compounds below 300° C., and since at these temperatures rubber components, compatibilizers and conventional additives generally lack sufficient stability, they cannot be used to prepare impact-modified polymer mixtures.

Impact-modified thermoplastic polymer mixtures have been described based on graft rubbers with a graft core based on acrylate, on butadiene or on EPDM (ethene-propene-diene copolymer) and with graft shells made from polymethyl methacrylate or poly(styrene-co-acrylonitrile), for example by L. A. Utracki, “Commercial Polymer Blends”, Chapman & Hall, 1998, London. These compounds are used in a wide variety of ways, mostly as a blend component. Certain aspects of the behavior of these polymer mixtures are unsatisfactory, for example their mechanical properties, in particular at high temperature.

It would be desirable to have access to impact-modified thermoplastic polymer mixtures which are not associated with any problems of demixing, have very good thermal stability and have very good mechanical properties over a wide temperature range.

It is an object of the present invention, therefore, to provide, in a simple and cost-effective manner, polymer mixtures which have a good mechanical property profile, in particular high heat resistance, toughness and stiffness, especially at high temperatures.

We have found that this object is achieved by impact-modified thermoplastic polymer mixtures which essentially comprise sulfur dioxide copolymers (component A) and at least one polymeric rubber compound with an elastomeric property profile (component B) and, if desired, comprise thermoplastic polymers (component C) and processing aids, colorants, stabilizers, antioxidants or reinforcing materials (component D).

Preferred novel impact-modified thermoplastic polymer mixtures comprise from 1 to 99% by weight, particularly preferably from 30 to 95% by weight and in particular from 45 to 92% by weight, of component A) and from 1 to 99% by weight, particularly preferably from 5 to 70% by weight and in particular from 8 to 55% by weight, of component B), based in each case on the total weight of the polymer mixture.

In another preferred embodiment the amount of component A) present is from 2 to 90% by weight, preferably from 5 to 80% by weight and particularly preferably from 6 to 70% by weight, that of component B) is from 2 to 80% by weight, preferably from 5 to 70% by weight and particularly preferably from 6 to 65% by weight and that of component C) is from 5 to 96% by weight, preferably from 10 to 90% by weight and particularly preferably from 20 to 88% by weight, based in each case on the total weight of the polymer mixture. The total of the percentages by weight is always 100.

Suitable SO₂-containing copolymers are those which have an aliphatic main chain (component A). Possible comonomers, besides sulfur dioxide, are in particular vinyl aromatic compounds and polar olefinically unsaturated cyclic or acyclic comonomers, such as (meth)acrylic acid, esters and amides of (meth)acrylic acid, (meth)acrylonitrile or (meth)acrolein. For the purposes of the present invention, suitable SO₂ copolymers include binary, ternary, tetrameric or higher copolymer systems. The individual copolymer units may have a random distribution, or alternate or be in the form of block segments in the copolymer. Ternary SO₂ copolymers are preferably utilized.

Suitable vinyl aromatic comonomers are in principle any mono- or polynucleic aromatic compound which has one or more vinyl groups. The aromatic ring systems in these compounds may also be heteroaryl and contain, for example, one or more heteroatoms such as O, S and/or N as ring atoms. The ring systems may moreover have substitution by any desired functional groups. Preferred vinyl aromatic compounds are mono- or binuclear aromatic or heteroaromatic ring systems made from 5 to 10 ring atoms, having 0, 1, 2 or 3 heteroatoms and either unsubstituted or alkyl- or halo-substituted. A preferred heteroatom is nitrogen. Examples of suitable heteroaromatic vinyl compounds are 2-vinylpyridine and 4-vinylpyridine. Suitable polynuclear vinylaromatic compounds are 4-vinylbiphenyl and 4-vinylnaphthalene.

Particular vinylaromatic comonomers are compounds of the formula (II)

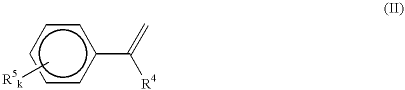

where R⁴ is hydrogen, C₁-C₈-alkyl or halogen and R⁵ is C₁-C₈-alkyl or halogen and k is 0, 1, 2 or 3. Particularly suitable vinylaromatic compounds (II) are styrene, α±methylstyrene, o-, m- or p-methylstyrene, p-ethylstyrene, 3-vinyl-o-xylene, 4-vinyl-o-xylene, 2-vinyl-m-xylene, 4-vinyl-m-xylene, 5-vinyl-m-xylene, 2-vinyl-p-xylene, 1,4-divinylbenzene, diphenylethylene or any desired mixture of the abovementioned vinylaromatic compounds. Particular preference is given to the use of α-methylstyrene and styrene as vinylaromatic comonomers, and styrene is very particularly preferred.

It is, of course, also possible to use any desired mixture of vinylaromatic comonomers.

Suitable polar unsaturated comonomers include compounds of the formula (I)

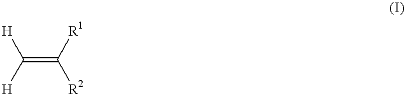

where R¹ is hydrogen or methyl and R² is CN, CHO or COOR³, where R³=hydrogen or C₁-C₂₀-alkyl.

Examples of suitable polar olefinically unsaturated comonomers are vinyl cyanides, such as acrylonitrile or methacrylonitrile, (meth)acrylic acid, C₁-C₂₀-alkyl or C₆-C₁₅-aryl (meth)acrylates or mixtures of these. Particularly suitable (meth)acrylates are methyl, ethyl, propyl, n-butyl, tert-butyl, 2-ethylhexyl, glycidyl and phenyl (meth)acrylate. Particular preference is given to acrylic acid, methacrylic acid, methyl, ethyl, propyl, n-butyl, tert-butyl and 2-ethylhexyl acrylate, and also to methyl methacrylate, acrylonitrile, vinyl acetate and acrolein, and mixtures of these. Acrylonitrile in particular is utilized as polar unsaturated comonomer.

Other suitable comonomers, instead of or alongside the polar α-olefins, are cyclic olefins having nonconjugated double bonds. These compounds may have two or more nonconjugated double bonds. Examples of suitable compounds are 1,4-cyclohexadiene, 1,4-cycloheptadiene, 1,4-cyclooctadiene, 1,5-cyclooctadiene, norbornadiene, 5-ethylidene-2-norbornene or mixtures of these. 1,5-Cyclooctadiene is particularly preferred.

If desired, use may also be made of linear or branched olefins, in particular α-olefins, as acyclic aliphatic nonpolar comonomers, for example ethene, propene, 1-butene, isobutene, 1-hexene, 1-octene or 1-dodecene or mixtures of these. It is, of course, also possible to use mixtures of the abovementioned unsaturated nonpolar compounds, or else any desired mixture made from polar and nonpolar olefins.

Suitable binary SO₂ copolymers contain in particular a vinylaromatic compound, preferably styrene, as a further comonomer alongside SO₂. These copolymers, and their preparation, are described, for example, in U.S. Pat. No. 2,572,185. Binary copolymers may also be based on sulfur dioxide and olefinically unsaturated polar comonomers, in particular acrylates, e.g. as described in Tsonis et al., Makromol. Chem. Rapid Commun., 1989, 10, 641-644. Examples of suitable binary sulfur dioxide copolymers based on olefinically unsaturated nonpolar compounds are disclosed, for example, in U.S. Pat. No. 3,331,819. Finally, reference may also be made to Enomoto et al., Bull. Chem. Soc. Jap., 1971, 44, 3140-3143, Matsuda et al., Macromolecules, 1972, 5, 240-246, and also Cais et al., Macromolecules, 1977, 254-260, for the preparation of SO₂-styrene copolymers by free-radical polymerization in bulk or solution.

It is preferable for ternary SO₂ copolymers to be used as component A) in the novel polymer mixtures. Preferred ternary copolymers contain, besides sulfur dioxide, a vinylaromatic compound, preferably styrene, as a comonomer unit. Olefinically unsaturated nonpolar compounds, in particular nonconjugated cycloolefins, or olefinically unsaturated polar compounds, in particular acrylates, vinyl acetate, acrolein or acrylonitrile, are also possible comonomers. Preference is given to ternary copolymers based on sulfur dioxide, on vinylaromatic comonomers, in particular styrene, and on acrylonitrile or acrylates, such as methyl, butyl or 2-ethylhexyl acrylate.

The proportion of sulfur dioxide incorporated into the terpolymer is usually from 0.1 to 50 mol % and preferably from 3 to 40 mol %, based on the copolymer A). The proportion of vinylaromatic compounds is generally from 1 to 99 mol % and preferably from 10 to 92 mol %. The proportion of olefinically unsaturated polar and/or nonpolar compound is normally from 0.9 to 70 mol % and preferably from 5 to 40 mol %.

For the purposes of the present invention, SO₂ copolymers also include copolymers which contain sulfur dioxide, vinylaromatic compounds, and also nonpolar and polar olefinically unsaturated compounds as comonomer units, for example a copolymer containing SO₂, a vinylaromatic compound, such as styrene or α-methylstyrene, acrylonitrile, n-butyl acrylate or methyl methacrylate as polar olefinically unsaturated compound and, for example, 1,5-cyclooctadiene or ethene, propene or 1-butene as nonpolar olefin.

A process for preparing suitable SO₂ copolymers will be described in more detail below by way of example. In this process, sulfur dioxide and all of the other comonomer units are polymerized by a free-radical route in suspension, bulk, solution or emulsion at from −80 to 250° C. The polymerization may be carried out either thermally or using a free-radical chain initiator.

The initial molar ratio of sulfur dioxide to olefinically unsaturated compounds, i.e. the total amount of comonomer units used other than sulfur dioxide, is usually from 20:1 to 1:20, preferably from 10:1 to 1:10 and particularly preferably from 5:1 to 1:5.

In the case of the preferred terpolymers or higher copolymer systems, the initial molar ratio of vinylaromatic comonomer to the other olefinically unsaturated compounds may be varied within a wide range and be from 50:1 to 1:50, preferably from 5:1 to 1.1:1, and particularly preferably from 3:1 to 1.1:1.

The free-radical chain initiators used may comprise organic or inorganic peroxides or hydroperoxides, such as potassium peroxodisulfate or sodium peroxodisulfate, percarbonates, azo compounds and/or compounds having labile C—C single bonds. Use may also be made of redox systems, e.g. a system composed of cumin hydroperoxide, iron(III)-EDTA complex and Rongalit®C. It is also possible to use substances which form redox systems with sulfur dioxide. Other free-radical polymerization initiators which may be used are monomers which polymerize spontaneously at elevated temperatures, e.g. styrene.

Suitable peroxides or hydroperoxides are dibenzoyl peroxide, lauroyl peroxide, 2,4-dichlorobenzoyl peroxide, bis(4-tert-butylcyclohexyl) peroxydicarbonate, tert-butyl peroxypivalate, hydrogen peroxide, cumin peroxide, tert-butyl hydroperoxide, peracetic acid and dicetyl peroxydicarbonate (e.g. Perkadox 24®). Particularly suitable azo compounds are 2,2′-azobis(isobutyronitrile) (AIBN) and 2,2′-azobis (2-methylbutyronitrile). Compounds having labile C—C bonds and whose use is preferred are 3,4-dimethyl-3,4-diphenylhexane and 2,3-dimethyl-2,3-diphenylbutane. Preferred substances which form redox systems with sulfur dioxide are chlorates, perchlorates, persulfates, and nitrates, such as silver nitrate, lithium nitrate and ammonium nitrate.

Other suitable free-radical chain initiators are oxygen, ozonides, trimethylamine oxide, dimethylaniline oxide, 2,2,6,6-tetramethylpiperidinyloxy (TEMPO) and its derivatives, N₂O and NO₂.

It is also possible to use mixtures of the free-radical chain initiators mentioned.

The amount of free-radical chain initiator used is usually from 0.01 to 10% by weight, preferably from 0.1 to 5% by weight, based on the amount of comonomers used. These quantity data do not of course relate to cases where a monomer is initiator and is thermally initiated, as is possible with the comonomer system SO₂/styrene, for example.

In bulk polymerization the monomers are polymerized without addition of any other reaction medium, using the monomer-soluble initiators mentioned, i.e. monomers are the reaction medium. Thermal initiation is also possible.

The solution polymerization differs from the bulk polymerization primarily in that there is concomitant use of an organic solvent to dilute the monomers. Examples of suitable solvents are aliphatic or aromatic hydrocarbons, such as pentane, hexane, heptane, ligroin, cyclohexane, benzene, ethylbenzene, toluene, xylene, alcohols, such as methanol, ethanol, n-propanol, isopropanol, n-butanol and isobutanol, ethers, such as diethyl ether, p-dioxane, halogenated hydrocarbons, such as dichloromethane, chlorobenzene and o-dichlorobenzene, and also sulfolane, dimethyl sulfoxide, pyridine, dimethylformamide, N-methylpyrrolidone, cyclohexanone, acetone, water, phenol, cresol and acetonitrile. Preferred solvents are dichloromethane, toluene and ethylbenzene. The free-radical chain initiators mentioned may also be used in the solution polymerization, or thermal initiation may be used.

To carry out the present process, SO₂, the vinylaromatic compound and an unsaturated polar and/or nonpolar compound, if desired together with a solvent and, if desired, with a free-radical chain initiator are placed in a reaction vessel. It is also possible for individual components to form an initial charge, for example the vinylaromatic compound, the unsaturated polar or nonpolar compound or the free-radical chain initiator, and for the components not yet present, for example SO₂, then to be added. The components mentioned may be gaseous or liquid.

Suitable reaction vessels for continuous operation of the present process are tubular reactors, loop reactors, (continuous) stirred-tank reactors and cascades of stirred reactors. Examples of reaction vessels suitable for batch operation, which is also possible, are stirred autoclaves and steel ampoules.

To obtain reproducibly good productivity it is preferable for the reaction mixture to be mixed intensively. For this, use may be made of suitable stirring devices, such as anchor stirrers, disk agitators, blade stirrers or helical stirrers. Suitable stirring rates are from 5 to 1100 rpm, preferably more than 10 rpm.

The polymerization is carried out at from −80 to 250° C., preferably from 0 to 190° C., particularly preferably from 10 to 170° C.

The polymerization may in principle be carried out at subatmospheric pressure, at atmospheric pressure or at superatmospheric pressure. The pressure is usually set at from 1 to 300 bar, preferably from 2 to 30 bar.

The polymerization time may be from 15 minutes to 10 days, preferably from 30 minutes to 24 hours, particularly preferably from 1 to 10 hours.

The reaction may be terminated by adding free-radical scavengers, e.g. quinones, hydroquinones, benzothiazine or diphenylpicrylhydrazyl, 2,2,6,6-tetramethylpiperidine-N-oxyl, diethylhydroxylamine or sterically hindered phenols.

Once the polymerization has finished, the polymer formed is either isolated directly, for example by removing the solvent by means of heat and/or in vacuo, filtration or—if necessary—first precipitated by introducing the reaction mixture into a solvent in which the polymer is insoluble, and then isolated. Finally, the polymer may be dried at an elevated temperature. Excess monomers and solvent may be removed in vacuo. The resultant polymers are generally transparent or translucent.

The molecular weights of the SO₂ copolymers prepared by the novel process may be varied over a wide range by an appropriate choice of the process parameters. It is also possible here to use regulators during the reaction, for example halohydrocarbons, mercaptans, dimeric α-methylstyrene, terpenes, Co(II) complexes or ethylbenzene. The molar masses usually obtained are from 20,000 to 1,000,000 g/mol. The polydispersity M_{w}/Mₙ is usually from 1 to 5. SO₂ copolymers from the process described usually have glass transition temperatures above 110° C., even up to 200° C. This generally means that high softening points are achieved for moldings. The copolymers obtained are moreover very heat-resistant. These polymers usually have little or no weight loss even when annealed for a number of hours at 200° C. or above.

The sulfur dioxide copolymers (component A) described form novel polymer mixtures with polymeric rubber compounds which have an elastomeric property profile (component B). Examples of possible components B) are graft polymers, block polymers, natural rubber, polybutadiene, polyisoprene, copolymers made from butadiene and from isoprene, and any desired mixture of the abovementioned compounds. The rubbers used have elastomeric properties. A measure of this elastomeric property is the glass transition temperature according to K. H. Illers and H. Breuer, Kolloid-Zeitschrift 1961, 176, p. 110. The polymeric rubber compounds are elastomeric polymers with a glass transition temperature (T_{g} determined by DSC at a heating rate of 10 K/min) of preferably below 0° C., with preference below −10° C. and particularly preferably below −20° C. Monomers which may be used for preparing B) are any of those monomers or monomer mixtures which give elastomeric polymers.

Examples of suitable monomers for preparing the polymers B) are conjugated dienes, such as butadiene or isoprene, alkyl acrylates or alkyl methacrylates, for example n-butyl acrylate, 2-ethylhexyl acrylate and other C₄-C₁₀-alkyl acrylates, and also monomers which polymerize to give crosslinked silicone rubbers, for example dimethylsiloxane, or mixtures of these monomers.

Possible components B) include core-shell graft polymers having at least one phase with a glass transition temperature below 0° C. These graft polymers have a graft core and one or more shells, and the rubber phase(s) may be present as core or graft envelope. It may, for example, be advantageous for certain applications to use a crosslinked core made from a hard (co)polymer, e.g. from styrene, from acrylonitrile and/or from an ester of (meth)acrylic acid. It is also possible for the rubber phase to form the outer envelope or for the rubber phase to have no graft envelope. Preferred graft polymers have at least one rubber phase which is not an outer shell.

The rubber phase may be in crosslinked or non-crosslinked form.

Examples of suitable graft polymers are those with a rubber with a glass transition temperature below 0° C. as graft base or graft core. Possible graft bases or graft cores are polybutadiene, polyisoprene, copolymers of butadiene and isoprene and copolymers of butadiene and/or isoprene with styrene or with a styrene having up to 12 carbon atoms and substitution in the α position or preferably on the ring by an alkyl group (or by one or more alkyl groups on the ring), preferably by methyl. The graft base or the graft core of the graft copolymer preferably has a glass transition temperature below −20° C. and in particular below −30° C.

In one preferred embodiment the graft polymers contain, based on B),

b1) from 30 to 95% by weight, preferably from 40 to 90% by weight and particularly preferably from 40 to 85% by weight, of an elastomeric base made from, based on b1),

b11) from 50 to 100% by weight, preferably from 60 to 100% by weight and particularly preferably from 70 to 100% by weight, of a C₁-C₁₀-alkyl acrylate, preferably n-butyl acrylate or 2-ethylhexyl acrylate, in particular n-butyl acrylate,

b12) from 0 to 10% by weight, preferably from 0 to 5% by weight and particularly preferably from 0 to 2% by weight, of a polyfunctional, crosslinking monomer, and

b13) from 0 to 40% by weight, preferably from 0 to 30% by weight and particularly preferably from 0 to 20% by weight, of one or more other monoethylenically unsaturated monomers,

or from

b11*) from 50 to 100% by weight, preferably from 60 to 100% by weight and particularly preferably from 65 to 100% by weight, of a diene having conjugated double bonds, and

b12*) from 0 to 50% by weight, preferably from 0 to 40% by weight and particularly preferably from 0 to 35% by weight, of one or more monoethylenically unsaturated monomers, and

b2) from 5 to 70% by weight, preferably from 10 to 60% by weight and particularly preferably from 15 to 60% by weight, of a graft made from, based on b2),

b21) from 50 to 100% by weight, preferably from 60 to 100% by weight and particularly preferably from 65 to 100% by weight, of a styrene compound of the formula

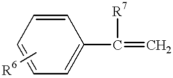

where R⁶ and R⁷ are hydrogen or C₁-C₈-alkyl or halogen, such as fluorine, chlorine or bromine, in particular styrene or α-methylstyrene,

b22) from 0 to 40% by weight, preferably from 0 to 38% by weight and particularly preferably from 0 to 35% by weight, of acrylonitrile or methacrylonitrile or a mixture of these, in particular acrylonitrile, and

b23) from 0 to 40% by weight, preferably from 0 to 30% by weight and particularly preferably from 0 to 20% by weight, of one or more other monoethylenically unsaturated monomers, in particular methyl methacrylate.

Particularly suitable C₁-C₁₀-alkyl acrylates, component b11), are ethyl acrylate, 2-ethylhexyl acrylate and n-butyl acrylate. 2-Ethylhexyl acrylate and n-butyl acrylate are preferred, and n-butyl acrylate is very particularly preferred. It is also possible to use mixtures of various alkyl acrylates whose alkyl radicals differ.

Crosslinking monomers b12) are bi- or polyfunctional comonomers having at least two olefinic double bonds, for example butadiene or isoprene, divinyl esters of dicarboxylic acids, such as succinic acid or adipic acid, diallyl or divinyl ethers of dihydric alcohols, for example those of ethylene glycol and of 1,4-butanediol, diesters of acrylic acid or methacrylic acid with the dihydric alcohols mentioned, 1,4-divinylbenzene or triallyl cyanurate. Particular preference is given to tricyclodecenyl acrylate (see DE-A 12 60 135), known by the name dihydrodicyclopentadienyl acrylate, and also to allyl acrylate and allyl methacrylate.

Crosslinking monomers b12) may be present or absent in the molding compositions, depending on the nature of the molding compositions to be prepared, in particular depending on the desired properties of the molding compositions.

If crosslinking monomers b12) are present in the molding compositions, the amounts are from 0.01 to 10% by weight, preferably from 0.3 to 8% by weight and particularly preferably from 1 to 5% by weight, based on b1).

Examples of the other monoethylenically unsaturated monomers b13) which may be present in the graft core b1) replacing to some extent the monomers b11) and b12) are:

vinylaromatic monomers, such as styrene, styrene derivatives of the formula

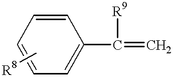

where R⁸ and R⁹ are hydrogen or C₁-C₈-alkyl;

acrylonitrile, methacrylonitrile;

C₁-C₄-alkyl (meth)acrylates, such as methyl (meth)acrylate, ethyl (meth)acrylate, n-propyl (meth)acrylate, isopropyl (meth)acrylate, n-butyl (meth)acrylate, isobutyl (meth)acrylate, sec-butyl (meth)acrylate, tert-butyl (meth)acrylate, ethylhexyl (meth)acrylate, and also hydroxyethyl acrylate, and moreover the glycidyl esters, glycidyl acrylate and glycidyl methacrylate;

acrylic acid, methacrylic acid, and moreover dicarboxylic acids, such as maleic acid and fumaric acid, and also anhydrides of these, such as maleic anhydride;

nitrogen-functional monomers, such as dimethylaminoethyl acrylate, diethylaminoethyl acrylate, vinylimidazole, vinylpyrrolidone, vinylcaprolactam, vinylcarbazole, vinylaniline, acrylamide;

aromatic and araliphatic esters of acrylic or methacrylic acid, such as phenyl acrylate, phenyl methacrylate, benzyl acrylate, benzyl methacrylate, 2-phenylethyl acrylate, 2-phenylethyl methacrylate, 2-phenoxyethyl acrylate and 2-phenoxyethyl methacrylate;

N-substituted maleinimides, such as N-methyl-, N-phenyl- and N-cyclohexylmaleinimide;

unsaturated ethers, such as vinyl methyl ether

and also mixtures of these monomers.

Preferred monomers b13) are styrene, acrylonitrile, methyl methacrylate, glycidyl acrylate, glucidyl methacrylate, acrylamide and methacrylamide.

It is also possible for the base to have been built up from the monomers b11*) and b12*) instead of the base monomers b11) to b13).

Possible dienes b11*) having conjugated double bonds are butadiene, isoprene, norbornene, halogen-substituted derivatives of these, such as chloroprene, and also mixtures of these. Butadiene and isoprene are preferred, in particular butadiene.

Other monoethylenically unsaturated monomers b12*) which may be used concomitantly are those mentioned above for the monomers b13).

Preferred monomers b12*) are styrene, acrylonitrile, methyl methacrylate, glycidyl acrylate, glycidyl methacrylate, acrylamide and methacrylamide.

The graft core b1) may also have been built up from a mixture of the monomers b11) to b13), and b11*) to b12*).

It is preferable for the graft shell b2) to have been built up from polystyrene, from copolymers of styrene and acrylonitrile, from copolymers of α-methylstyrene and acrylonitrile or from copolymers of styrene and methyl methacrylate.

Suitable rubber components B) are also present in cases where the soft rubber phase is grafted with compounds containing reactive functional groups, such as carboxylic acid, anhydride or epoxy.

The particle size of the abovementioned rubber phase is preferably from 0.05 to 1 μm.

The component B) used may comprise the abovementioned graft polymers as such, or else in the form of graft bases or graft cores, or as a mixture of different graft polymers with different compositions and/or sizes, or in a blend with another polymer.

Particularly suitable blends are those with polymers made from vinylaromatic compounds and acrylonitrile. Preferred embodiments of component B) therefore also relate to those known as ABS and ASA materials and mixtures of these.

If the graft core comprises the monomers b11) to b13), then blending with a polymer made from styrene and acrylonitrile (SAN) gives ASA (acrylonitrile-styrene-alkyl acrylate) materials. These are generally polystyrene-acrylonitrile-grafted polyacrylate rubber particles which are present within a polystyrene-acrylonitrile matrix. If the graft core comprises the monomers b11*) to b12*), blending with a polymer made from styrene and acrylonitrile (SAN) gives ABS (acrylonitrile-butadiene-styrene) materials. These are generally polystyrene-acrylonitrile-grafted polybutadiene rubber particles which are present within a polystyrene-acrylonitrile matrix.

The ABS graft polymers and ASA graft polymers are obtainable in a manner known per se, preferably by emulsion polymerization or microsuspension polymerization.

The graft b2) may be prepared under the conditions used to prepare the base b1), and the graft b2) may be prepared in one or more steps. For this, the monomers b21), b22) and b23) may be added individually or in a mixture with one another. The monomer ratio in the mixture may be constant over time or have a gradient. Combinations of these procedures are also possible.

It is possible, for example, for first styrene on its own and then a mixture made from styrene and acrylonitrile to be polymerized onto the base b1).

Mixtures of the abovementioned graft polymers which differ in their particle size and/or particle structure may also be used.

The abovementioned core-shell graft polymers B) are obtainable in a manner known per se, preferably by emulsion polymerization at from 30 to 95° C. Examples of emulsifiers suitable for this are the alkali metal salts of alkyl- or alkylarylsulfonic acids, and other examples of suitable emulsifiers are alkyl sulfates, fatty alcohol sulfonates, salts of higher fatty acids having from 10 to 30 carbon atoms, sulfosuccinates, ethersulfonates and resin soaps. It is preferable to use the alkali metal salts of alkylsulfonates or fatty acids having from 10 to 18 carbon atoms.

The amount of water used to prepare the dispersion is preferably sufficient to give the finished dispersion a solids content of from 20 to 50% by weight.

Polymerization initiators which may be used are preferably free-radical generators, for example peroxides, preferably peroxosulfates (such as potassium peroxodisulfate), or azo compounds, such as azodiisobutyronitrile. However, redox systems may also be used, in particular those based on hydroperoxides, such as cumin hydroperoxide.

Concomitant use may also be made of molecular weight regulators, e.g. ethylhexyl thioglycolate, t-dodecyl mercaptan, terpinols or dimeric α-methylstyrene.

In order to maintain constant pH, preferably at from 6 to 9, concomitant use may be made of buffer substances, such as Na₂HPO₄/NaH₂PO₄ or sodium hydrogencarbonate.

The amounts of emulsifiers, initiators, regulators and buffer substances used are the customary amounts, and further details of these would therefore be superfluous.

The graft core may also particularly preferably be prepared by polymerizing the monomers b1) in the presence of a fine-particle rubber latex in what is known as the seed-latex polymerization procedure.

The principle also includes the possibility of preparing the graft core b1) by a process other than emulsion polymerization, e.g. by bulk or solution polymerization, and then emulsifying the resultant polymers. Another method is the miniemulsion procedure, in which the monomers are emulsified in water by means of ultrasound or of a high-pressure homogenizer. This process generally uses water-soluble initiators. Methods for this process are known. Microsuspension polymerization is also suitable, in particular if large-particle elastomeric polymers are to be obtained, and it is preferable here to use oil-soluble initiators, such as lauroyl peroxide or tert-butyl perpivalate. In this process the monomers, which correspond to the desired polymer B), are dispersed in water using at least one protective colloid, giving a dispersion of the monomer droplets in water with a volume-median particle diameter d₅₀ of from 100 nm to 100 mm. The droplets are then polymerized using a free-radical polymerization initiator.

The graft shell b2) may be prepared under the conditions used for preparing the graft core b1), and the envelope b2) may be prepared in one or more steps. For example, styrene, and respectively, α-methylstyrene may first be polymerized on their own, followed by styrene and acrylonitrile in two steps in sequence. Further details of the preparation of the graft polymers B) are given in DE-A 12 60 135 and 31 49 358.

Other suitable polymeric rubbers B) are silicone rubbers. These are generally crosslinked silicone rubbers made from units of the formulae R₂SiO, RSiO_{3/2}, R₃SiO_{1/2} and SiO_{2/4}, where R is a monovalent radical and in the case of R₃SiO_{1/2} may, if desired, also be OH. The amounts of the individual siloxane units here are usually adjusted so that for every 100 units of the formula R₂SiO there are from 0 to 10 molar units of the formula RSiO_{3/2}, from 0 to 1.5 molar units of R₃SiO_{1/2} and from 0 to 3 molar units of SiO_{2/4}.

R here is generally C₁-C₁₈-alkyl, preferably C₁-C₁₂-alkyl, particularly preferably C₁-C₆-alkyl, such as methyl, ethyl, n-propyl, isopropyl, n-butyl, isobutyl, sec-butyl, tert-butyl, pentyl or hexyl, in particular methyl or ethyl, or C₆-C₁₀-aryl, such as phenyl or naphthyl, in particular phenyl, or C₁-C₁₀-alkoxy or aryloxy, such as methoxy, ethoxy or phenoxy, preferably methoxy, or groups capable of attack by free radicals, for example vinyl, allyl, acrylic, acryloxy, methacrylic, methacryloxyalkyl, halo or mercapto groups, preferably vinyl or mercapto-C₁-C₁₀-alkyl, in particular mercaptopropyl, vinyl or methacryloxypropyl.

In one particular embodiment, silicone rubbers are used in which at least 80% of all of the radicals R are methyl. Preference is also given to silicone rubbers in which R is methyl or ethyl.

In another embodiment, silicone rubbers are used which contain, based on all of the radicals R, from 0.01 to 10 mol %, preferably from 0.2 to 2 mol % of the abovementioned groups capable of attack by free radicals. Silicone rubbers of this type are described in EP-A 260 558 and EP-A 492 376, for example.

Other resins which may be used are the silicone rubbers described in DE-A 25 39 572. Those disclosed in EP-A 370 347 may also be used.

Silicone rubbers may moreover form a graft core for, for example, a graft or graft envelope formed from acrylates, e.g. butyl acrylate, or from vinylaromatic monomers, such as styrene, acrylonitrile and/or methyl methacrylate or a mixture of these. Preferred graft envelopes are composed of the components styrene and acrylonitrile.

Silicone rubbers may be added to the polymer mixture in solid form or as a dispersion, for example.

In another embodiment, component B) is an elastomeric block copolymer made from two or more blocks, and at least one block has a T_{g} below 0° C. while another block has a T_{g} above 0° C. Preference is given to three- or multiblock systems and among three-blocks those having at least one outer block with a T_{g} above 0° C. are particularly preferred.

Particular preference is given to three- or multiblock systems in which the soft phase (T_{g} below 0° C.) has been built up from acrylate blocks, in particular from n-butyl and/or 2-ethylhexyl acrylate, and the hard phase (T_{g} above 0° C.) has been built up from methyl methacrylate. Blockcopolymers of this type are obtainable in a known manner by anionic polymerization.

In another embodiment component B) is an elastomeric block copolymer made from at least one B_{A} block which forms a hard phase and has copolymerized units of a vinylaromatic monomer and from at least one block B_{A} which forms a soft phase and has copolymerized units of a vinylaromatic monomer and also of a diene and from at least one block B_{B/A} which forms a soft phase and has copolymerized units of a vinylaromatic monomer and also of a diene, where the glass transition temperature T_{g} of the block B_{A} is above 25° C., preferably above 50° C. and that of the block B_{B/A} is below 25° C., preferably below 5° C. The phase volume ratio of block B_{A} to block B_{B/A} is generally selected so that the proportion of the hard phase in the entire block copolymer is from 1 to 40% by volume and the proportion of the diene is below 50% by weight, and the relative proportion of 1,2-linkages in the polydiene, based on the sum of 1,2- and 1,4-cis/trans linkages is below about 15%, preferably below 12%.

Preferred vinylaromatic compounds for the elastomeric block copolymer are styrene and moreover α-methylstyrene, 1,1-diphenylethylene and vinyltoluene, and also mixtures of these compounds. Preferred dienes are butadiene and isoprene, and also piperylene, and 1-phenylbutadiene, and also mixtures of these compounds. In the abovementioned block polymers, the soft phase, e.g. the polybutadiene block, may also be in partly or completely hydrogenated form. A particularly preferred monomer combination is butadiene and styrene, e.g. in the form of a styrene/butadiene/styrene block polymer. Examples of suitable styrene/butadiene block copolymers in which the polybutadiene blocks may also be in partly or completely hydrogenated form are available with the trade names Kraton® and Cariflex® (Shell AG).

All of the weight and volume data below are based on the comonomer combination styrene/butadiene; if the technical equivalents of styrene and butadiene are used, the data has to be recalculated accordingly where appropriate.

The B_{B/A} block has been built up from 75-30% by weight of styrene and 25-70% by weight of butadiene, for example. A particularly preferred soft block has a butadiene content of from 35 to 70% and a styrene content of from 65 to 30%.

In the case of the monomer combination styrene/butadiene, the proportion by weight of the diene in the entire block copolymer is from 15-65% by weight, and that of the vinylaromatic component is correspondingly from 85-35% by weight. Particular preference is given to butadiene-styrene block copolymers with a monomer composition of from 25-60% by weight of diene and from 75-40% by weight of vinylaromatic compound.

A block copolymer B) may have one of the formulae 1 to 3, for example:

(B_{A}−B_{(B/A)})ₙ; (1)

(B_{A}−B_{(B/A)})ₙ−B_{A} or (2)

B_{(B/A)}−(B_{A}−B_{(B/A)})ₙ. (3)

Preference is likewise given to a block copolymer which has two or more blocks B_{(B/A)} and/or B_{A} each with a different molar mass in each molecule.

The block copolymers are preferably prepared by anionic polymerization in a nonpolar solvent, with initiation by organometallic compounds. Preference is given to compounds of the alkali metals, in particular of lithium. Examples of initiators are methyllithium, ethyllithium, propyllithium, n-butyllithium, sec-butyllithium and tert-butyllithium. The organometallic compound is added as a solution in a chemically inert hydrocarbon. The amount added depends on the desired molecular weight of the polymer, that is generally from 0.002 to 5 mol %, based on the monomers. Solvents used are preferably aliphatic hydrocarbons, such as cyclohexane or methylcyclohexane.

The random blocks present in the block copolymers and containing vinylaromatic together with diene are preferably prepared with addition of a soluble potassium salt, in particular of a potassium alcoholate.

More detailed data on the structure and the preparation of the block copolymers mentioned are disclosed in DE-A 19 615 533, which is expressly incorporated herein by way of reference. Further data and details concerning the block copolymers mentioned are also found in Knoll and Niessner in ACS Symposium Series 696, ed. R. P. Quirk, “Applications of Anionic Polymerization Research”, 1996, and also in Macromol. Symp. 1998, 132, 231-243, which are also expressly incorporated herein by way of reference. Other suitable elastomeric block copolymers are available with the trade name Styroflex® (BASF AG).

Other polymeric rubber compounds B) which may be used are polyurethanes, in particular thermoplastic polyurethanes, such as polyester polyurethanes and polyether polyurethanes. Polytetrahydrofuran is also suitable as component B), as are the homo- and copolymers of isobutene. The last named polymers are available commercially with the trade name Oppanol® (BASF AG).

In another embodiment, rubber compounds B) may derive from branched and, respectively, highly branched polyolefins, as long as these are sufficiently amorphous. It is therefore also possible for amorphous polyolefins which have partly crystalline segments to be used as component B). Highly branched polyolefins are generally composed of a polyethylene backbone with randomly distributed alkyl side branches, generally of different lengths. Highly branched polyolefins may be prepared exclusively from ethene, for example, with the aid of what are known as hybrid catalyst systems, i.e. by way of a combination of two catalyst systems, each of which participates in a different way in the course of the polymerization (see also WO 99/50318). Highly branched polyolefins may also be obtained from ethene with the aid of a specific nickel-diimine complex, as described by Brookhart et al., J. Am. Chem. Soc. 1995, 117, 6414-6415. These compounds are also obtainable from ethene and α-olefinic comonomers by way of transition metal catalysis (see also U.S. Pat. No. 5,272,236). Examples of suitable comonomers which may be used are C₃-C₁₀ α-olefins, such as propene, 1-butene, 1-pentene, 1-hexene and 1-octene, and mixtures of these. Comonomers having two or more double bonds are also suitable, for example conjugated dienes, such as isoprene or butadiene, non-conjugated dienes having from 5 to 25 carbon atoms, such as 1,4-pentadiene, 1,4-hexadiene, 1,5-hexadiene, 2,5-dimethyl-1,5-hexadiene and 1,4-octadiene, and also cyclic dienes, such as cyclopentadiene, cyclohexadiene, cyclooctadiene and dicyclopentadiene, and also alkenylnorbornenes, such as 5-ethylidene-2-norbornene, 5-butylidene-2-norbornene, 2-methallyl-5-norbornene and 2-isopropenyl-5-norbornene, and tricyclodienes, such as 3-methyltricyclo[5.2.1.0^{2,6}]-3,8-decadiene, and mixtures of these. Among these, preference is given to the use of 1,5-hexadiene, 5-ethylidenenorbornene and dicyclopentadiene. The diene content of the rubbers is preferably from 0.5 to 50% by weight, in particular from 1 to 8% by weight, based on the total weight of the rubber. It is also possible to incorporate into the polymerization α-olefins having polar functional groups, for example C₁-C₂₀ (meth)acrylates, such as n-butyl acrylate, ethyl acrylate or 2-ethylhexyl acrylate, into the polymer backbone (see also Brookhart et al., J. Am. Chem. Soc. 1996, 118, 267-268, and J. Am. Chem. Soc. 1998, 120, 888-899). The last named copolymer particles may also have been grafted with compounds which form a hard phase, in particular with styrene, acrylonitrile or (meth)acrylates, in particular methyl methacrylate.

It is, of course, also possible to use the elastomeric polymers B) mentioned in the form of any desired mixture.

The novel rubber-modified polymer mixtures may moreover also comprise suitable thermoplastics or mixtures of these (component C). Suitable thermoplastics which may be used are fundamentally any of the known polymers or polymer mixtures from this class of compounds. The materials in this class of compounds can be processed thermoplastically. Examples of suitable thermoplastic polymers are polyalkyl methacrylates, polystyrene, polyamides, polycarbonates, polyesters, polysulfones, polyurethanes, polyvinyl chloride, polyolefins, such as polyethylene and polypropylene, polyphenylene ethers and styrene (co)polymers, e.g. poly(styrene-co-acrylonitrile), and polymers based on the monomers styrene, acrylonitrile and butadiene or, respectively, styrene, acrylonitrile and an acrylate (ABS copolymers and, respectively, ASA copolymers), polymethacrylimides, polyacetals, polyacrylonitrile, and imidated and non-imidated copolymers made from styrene and maleic anhydride (MA), and mixtures of these.

Suitable styrene (co)polymers include polystyrene impact-modified with polybutadiene rubbers, for example the material known as high-impact polystyrene (HIPS), and also styrene (co)polymers with acrylonitrile as comonomer component, e.g. a styrene-acrylonitrile copolymer. The last named compounds, which are generally also termed SAN polymers or simply SAN and, respectively, PSAN, since their principle components are styrene and acrylonitrile, also include, for example, thermoplastic polymers which contain

c₁) from 50 to 100% by weight, preferably from 55 to 95% by weight and particularly preferably from 60 to 85% by weight, of styrene or α-methylstyrene or a mixture of these,

c₂) from 0 to 50, preferably from 5 to 45% by weight and particularly preferably from 15 to 40% by weight, of acrylonitrile, and also

c₃) from 0 to 50% by weight, preferably from 0 to 40% by weight, of one or more other monoethylenically unsaturated monomers,

based in each case on component C). These polymers are known and some of them are also available commercially. They generally have a viscosity number VN (determined to DIN 53 726 at 25° C., 0.5% strength by weight in dimethylformamide) of from 40 to 160 ml/g, corresponding to an average molecular weight (weight average) of from about 40,000 to 2,000,000. They are obtained in a known manner by bulk, solution, suspension, precipitation or emulsion polymerization. Details of these processes are described in Kunststoffhandbuch, ed. R. Vieweg and G. Daumiller, Vol. V “Polystyrol”, Carl-Hanser-Verlag, Munich 1969, pp. 118 et seq. Other suitable compounds c₃) are those described under component b13).

It is, of course, also possible to blend the novel polymer mixtures with rubber-modified styrene (co)polymers, preferably those prepared in bulk, solution, emulsion or in a combined bulk/solution process. These include polybutadiene-modified styrene-acrylonitrile copolymers, and also the material known as ABS (commercially available with the trade name Terluran® (BASF AG), for example), with polybutyl-acrylate-modified styrene-acrylonitrile copolymers, such as the material known as ASA (commercially available with the trade name Luran®S (BASF AG), for example), or with ethene-propene-diene(EPDM)-copolymer-modified styrene-acrylonitrile copolymers, such as the material known as AES. Here, the respective rubbers are usually present as a dispersion of particles in the styrene copolymer matrix. The ABS blends and ASA blends are preferably graft copolymers. They comprise a hard matrix which essentially comprises SAN, and also a particulate graft rubber dispersed in the matrix. In ABS, the rubber comprises a core based on polybutadiene, grafted with an SAN shell, and in the case of ASA it comprises a core based on crosslinked polyalkyl acrylate (in particular polybutyl acrylate), grafted with an SAN shell. The SAN shell may have been built up in one or more stages. For example, it may have a first (inner) stage made from styrene homopolymer and a second (outer) stage made from styrene-acrylonitrile copolymer, and the transition between the stages may be sharp or tapered (gradual). The core, too, may have been built up in one or more stages. In particular, it may have an inner stage made from styrene homo- or copolymer and an outer stage made from polybutadiene (in the case of ABS) and, respectively, polyalkyl acrylate (in the case of ASA) (see also Kunststoff Taschenbuch, H. Saechtling, 26th edition, Carl Hanser Verlag, Munich, 1995).

The styrene (co)polymers described, if desired impact-modified, are preferably prepared by solution or bulk polymerization or by combined bulk/solution polymerization. Solution polymerization is particularly preferred. In another embodiment, the rubber content is preferably prepared in emulsion, and the matrix material in bulk, solution, emulsion or suspension. Other details concerning the polymerization processes mentioned may be found by the skilled worker in “Ullmann's Encyclopedia of Industrial Chemistry”, 5th edition, Vol. A21, ed. Elvers et al., VCH Verlag, Weinheim 1992, pp. 355-393, or in “Handbuch der Technischen Polymerchemie” by A. Echte, VCH Verlag, Weinheim 1993, pp. 475-492.

Suitable copolymers made from styrene and maleic anhydride (MA) may be prepared, for example, by free-radical copolymerization of styrene with MA, preferably in solution or in bulk. The molar MA:styrene ratio is preferably from 1:1 to 0.01:1. The skilled worked will find further details in Ullmann's Enzyklopädie der Technischen Chemie, 14th edition, Verlag Chemie, Weinheim 1980, Vol. 19, Section on polystyrene Nos. 4.3 and 5.8.3.

Suitable imidated styrene-MA copolymers are obtained by a subsequent reaction of the styrene-MA copolymers with amines. During this, the functional group of the MA units is first amidated in a two-step reaction, followed by ring-closure to give the malimide. Examples of suitable amines are methylamine, ethylamine, cyclohexylamine and aniline. The reaction with the amines may, for example, take place in solution (for example in a stirred tank reactor) or else in the melt (e.g. continuously, in particular in an extruder: reactive extrusion).

Suitable polymethacrylimides are prepared in a manner similar to that for the imidated styrene-MA copolymers, by reacting PMMA with amines, as described in DE-A 41575, EP-A 549922, EP-A 576877 and DE-B 1165861.

An example of a preparation of styrene-phenylmaleimide copolymers, styrene-acrylonitrile-phenylmaleimide copolymers or methyl methacrylate-phenylmaleimide copolymers is free-radical solution polymerization of the appropriate monomers. Details are described in J. Macromol. Sci. A11, p. 267 (1977), U.S. Pat. No. 4,451,617 and U.S. Pat. No. 4,491,647.

Examples of suitable polycarbonates are those based on biphenols of the formula (III)

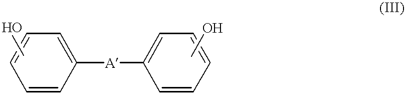

where A′ is a single bond, C₁-C₃-alkylene, C₂-C₃-alkylidene or C₃-C₆-cycloalkylidene or S or SO₂.

Examples of preferred biphenols of the formula (IV) are 4,4′-dihydroxybiphenyl, 2,2-bis(4-hydroxyphenyl)propane (bisphenol A), 2,4-bis(4-hydroxyphenyl)-2-methylbutane and 1,1-bis(4-hydroxyphenyl)cyclohexane. Other preferred biphenols are hydroquinone and resorcinol. Particular preference is given to 2,2-bis(4-hydroxyphenyl)propane, 2,2-bis(4-hydroxyphenyl)cyclohexane, 2,2-bis(4-hydroxyphenyl)-2,3,5-trimethylcyclohexane and 2,2-bis(4-hydroxyphenyl)-3,3,5-trimethylcyclohexane.

Suitable polyesters are likewise known and described in the literature (see also Kunststoffhandbuch 3/1). They generally derive from an aromatic dicarboxylic acid, and the aromatic skeleton may have substitution by halogen, such as chlorine or bromine, or by straight-chain or branched alkyl, preferably C₁-C₄-alkyl. Preferred dicarboxylic acids are naphthalenedicarboxylic acid, terephthalic acid and isophthalic acid, and dicarboxylic acids, which to some extent (generally up to 10 mol %) may have been replaced by aliphatic or cycloaliphatic dicarboxylic acids. A particularly suitable polyester component is polybutylene terephthalate. The viscosity number of the polyesters is generally from 60 to 200 ml/g (measured in a 0.5% by weight solution in a phenol/o-dichlorobenzene mixture).

Examples of suitable polyacetals are polyoxymethylenes, such as the commercially available product Ultraform® (Ultraform GmbH).

Suitable polycarbonates, polyacetals and polyesters, and also processes for their preparation, may be found in Kunststoff-Handbuch 3/1 “Technische Thermoplaste, Polycarbonate, Polyacetale, Polyester, Celluloseester”, ed. L. Bottenbruch, Hanser-Verlag, Munich, 1992, 117-299.

Suitable polyamides are known per se. Preference is very generally given to polyamides whose structure is aliphatic and semicrystalline or partly aromatic and also amorphous. Polyamide blends may also be used. Examples of suitable polyamides are obtainable with the trade name Ultramid® (BASF AG).

Examples of suitable poly(ether)sulfones are compounds such as the product called Ultrason® E or S (BASF AG). Suitable polysulfones are described, inter alia, by F. Zahradnik, “Hochtemperatur-Thermoplaste”, VDI Verlag GmbH, Düsseldorf, 1993.

Polyalkyl methacrylates include in particular polymethyl methacrylate, and also the copolymers based on methyl methacrylate with up to 40% by weight of other copolymerizable monomers, preferably C₁-C₄ acrylates. An example of the preparation of these polymeric materials is polymerization in bulk, emulsion, solution or suspension of methyl methacrylate (MMA) or MMA mixtures comprising preferably up to 20% by weight of comonomers. Examples of suitable comonomers are methyl, ethyl and butyl acrylate. Free-radical polymerization is usually used, preferably at from 40 to 150° C., or anionic polymerization at low temperatures, or coordinative polymerization using transition metal catalysts. PMMA polymerized by a free-radical or coordinative route preferably comprises products with particularly steric configurations. Bulk products are usually prepared in bulk, solution or suspension. More detail can be found by the skilled worker in H. Raudi-Puntigam, T. Völker: Chemie, Physik und Technologie der Kunststoffe in Einzeldarstellungen, Vol. 9: Acryl- und Methacrylverbindungen, Springer-Verlag 1967, for example. An example of a suitable polyalkyl methacrylate is marketed with the trade mark Lucryl® (Barlo Plastics GmbH).

In other respects the abovementioned thermoplastics are well known to the skilled worker, are polystyrene, polyvinyl chloride, polyolefins, polyphenylene ethers, polyurethanes and polyacrylonitrile. In relation to the preparation and properties of the polymers C), the following publications are incorporated herein by way of reference: W. Hellerich, Werkstoff-Führer Kunststoffe, Eigenschaften, Prüfung, Kennwerte, 7th edn., Carl Hanser Verlag, Munich, 1996, pp. 66-128, and also L. Bottenbruch, “Technische Thermoplaste, Hochleistungs-Kunststoffe”, Kunststoff-Handbuch 3/3, Carl Hanser Verlag, Munich, 1994, and A. Echte, “Handbuch der Technischen Polymerchemie”, VCH Verlag, Weinheim, 1993.

It is also possible to use any desired mixture of the abovementioned thermoplastic polymers. Among the polymer mixtures, particular preference is given to those made from polymethyl methacrylate and poly(styrene-co-acrylonitrile), from an acrylate-rubber-modified styrene-acrylonitrile copolymer, e.g. ASA, or in particular a butadiene-rubber-modified styrene-acrylonitrile copolymer, e.g. ABS, and polyamide, for example those obtainable with the trade mark Stapron®N (BASF AG), from a butadiene-rubber-modified styrene-acrylonitrile copolymer, e.g. ABS, or an acrylate-rubber-modified styrene-acrylonitrile copolymer, e.g. ASA, and polycarbonate, for example those obtainable with the trade mark Luran®SC (BASF AG), and also those made from a butadiene-rubber-modified styrene-acrylonitrile copolymer, e.g. ABS, or in particular an acrylate-rubber-modified styrene-acrylonitrile copolymer, e.g. ASA, and polybutylene terephthalate, for example those obtainable with the trade mark Ultradur®S (BASF AG).

Other suitable mixtures are composed of polyvinyl chloride and ASA, and also in particular ABS. It is also possible to use mixtures made from polymethyl methacrylate and styrene-acrylonitrile copolymers as hard component and from a soft component based on polybutadiene or a styrene-butadiene copolymer rubber grafted with styrene and acrylonitrile, as described in DE-A 28 28 517, for example. In this connection, particularly suitable mixtures have, as soft component, graft copolymers having a polybutadiene or styrene-butadiene block copolymer backbone and grafted-on branches made from (meth)acrylates, in particular methyl methacrylate, and, if desired, from vinyl aromatic compounds, in particular styrene. In relation to the preparation and properties of the last-named mixture, EP-A 062 223 is expressly incorporated herein by way of reference. These mixtures are also available commercially with the trade name Terlux® (BASF AG).

Preferred novel polymer mixtures have their bases in sulfur dioxide terpolymers comprising SO₂, a vinyl aromatic compound, in particular styrene, and a polar olefinically unsaturated compound, in particular acrylonitrile, and a thermoplastic polymer as described above. Among the thermoplastic polymers particularly preferred in this instance are styrene(co)polymers, in particular impact-modified styrene(co)polymers.

The novel polymer mixtures may also comprise, based on the mixture made from components A), B) and C), up to 50% by weight, preferably from 0.001 to 40% by weight, of customary additives, e.g. processing aids, colorants, stabilizers, antioxidants or reinforcing materials (component D).

Inorganic fillers which may be used are fibers or particulate materials, such as carbon fibers, glass fibers, glass beads, amorphous silica, asbestos, calcium silicate, calcium metasilicate, magnesium carbonate, kaolin, chalk, powdered quartz, mica, barium sulfate, and also Feldspar, at preferably from 1 to 40% by volume, particularly preferably from 20 to 35% by volume.

Oxidation retarders or antioxidants, and also heat stabilizers, which may be used are alkylphenols, in particular sterically hindered phenols, hydroxyphenylpropionates, hydroxybenzyl compounds, alkylidenebisphenols, hydroquinones, secondary aromatic amines, such as diphenylamine, thiobisphenols, aminophenols, thioethers, organic phosphites, hypophosphites and phosphonites, inorganic phosphites, inorganic hypophosphites, e.g. metal salts of phosphorous acid H₃PO₃ or of hypophosphorous acid H₃PO₂, in particular alkali metal phosphites and alkaline earth metal phosphites, the alkali metal or alkaline earth metal hydrogenphosphites, such as calcium hydrogen phosphite CaHPO₃, sodium hypophosphite NaH₂PO₂, or potassium hypophosphite KH₂PO₂, and also mixtures of these, in concentrations of up to 5% by volume, preferably from 0.03 to 3% by volume and particularly preferably from 0.05 to 1% by volume, based on the volume of the thermoplastic polymer mixture.

Preferred antioxidants are sterically hindered phenols, in particular those which contain an ester group, organic phosphites and phosphonites, in particular triaryl phosphites and triaryl phosphonites, for example triphenyl phosphite and triphenyl phosphonite, and also in particular mixtures of these.

All of the antioxidants mentioned are known and available commercially.

Examples of suitable UV stabilizers or light stabilizers are resorcinol and substituted resorcinols, salicylates, benzotriazoles, benzophenones, sterically hindered phenols, sterically hindered amines, in particular the tetraalkylpiperidin-N-oxy compounds, such as those known as HALS compounds, phosphites and nickel- or sulfur-containing compounds, and also mixtures of these. Mixtures made from benzotriazoles and from sterically hindered amines are particularly preferred. All of the UV stabilizers and light stabilizers mentioned are known and available commercially.

Examples of the sterically hindered phenol class of compounds are bis(2,6-tert-butyl)-4-methylphenol (BHT), 4-methoxymethyl-2,6-di-tert-butylphenol, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 2,4-di-tert-butylphenyl 3,5-di-tert-butyl-4-hydroxybenzoate, 2,2-bis(4-hydroxyphenyl)propane (bisphenol A), 4,4′-dihydroxybiphenyl (DOD), 2,2′-methylenebis(4-methyl-6-tert-butylphenol), 1,6-hexanediol 3-bis(3,5-di-tert-butyl-4-hydroxyphenyl)propionate, octadecyl 3-(3,5-bis(tert-butyl)-4-hydroxyphenyl)propionate, 3,5-di-tert-butyl-4-hydroxybenzyldimethylamine, 2,6,6-trioxy-1-phosphabicyclo-[2.2.2]oct-4-ylmethyl 3,5-di-tert-butyl-4-hydroxyhydrocinnamate and N,N′-hexamethylenebis-3,5-di-tert-butyl-4-hydroxyhydrocinnamide. Among the sterically hindered phenols mentioned, preference is given to bis(2,6-(C₁-C₁₀-alkyl)-4-(C₁-C₁₀-alkyl)phenols, and in particular bis(2,6-tert-butyl)-4-methylphenol and bis(2,6-methyl)-4-methylphenol.

Examples of the sterically hindered amine class of compounds are 2,2,6,6-tetramethyl-1-piperidinyloxy (TEMPO), 4-oxo-2,2,6,6-tetramethyl-1-piperidinyloxy (4-oxo-TEMPO), 4-hydroxy-2,2,6,6-tetramethyl-1-piperidinyloxy, 2,2,5,5-tetramethyl-1-pyrrolidinyloxy, 3-carboxy-2,2,5,5-tetramethylpyrrolidinyloxy, 2,6-diphenyl-2,6-dimethyl-1-piperidinyloxy, and also 2,5-diphenyl-2,5-dimethyl-1-pyrrolidinyloxy. It is, of course, also possible to use mixtures of the abovementioned compounds. Particularly preferred HALS compounds are bis(2,2,6,6-tetramethyl-4-piperidyl) sebacate and bis(2,2,6,6-tetramethyl-N-methyl-4-piperidyl) sebacate, available commercially with the trademarks Tinuvin®770 and, respectively, Tinuvin®765.

A preferred triazole compound is 2-(2′-hydroxy-5′-methylphenyl)benzotriazole (Tinuvin®(P).

The amounts used of the light stabilizers are up to 2% by weight, based on the polymer mixture. If more than one light stabilizer is used, the abovementioned amounts are the total amount.

It is also possible to add inorganic pigments, e.g. titanium dioxide, ultramarine blue, iron oxide or carbon black, or organic pigments, e.g. phthalocyanines, quinacridones or perylenes, or else dyes, e.g. nigrosine or anthraquinone.

Preferred lubricants and mold-release agents are long-chain fatty acids, e.g. stearic acid, salts of these, e.g. magnesium stearate, calcium stearate or zinc stearate, and montan waxes (mixtures of straight-chain, saturated carboxylic acids with chain lengths of from 28 to 32 carbon atoms), and also low-molecular-weight polyethylene waxes and low-molecular-weight polypropylene waxes.

The novel polymer mixtures may be prepared by mixing processes known per se, generally at from 150 to 350° C., for example with melting in an extruder, Banbury mixer or kneader, or on a roll mill or calender. The mixing of the components may take place in one or more stages, e.g. using extruders connected in series. The components may moreover be mixed with one another in suspension or as a solution and then isolated by precipitation. The components may also be mixed cold, without melting, whereupon the mixture composed of powder or of pellets is not melted and homogenized until it is processed. Whatever the procedure selected, the components may be admixed in any desired sequence.

In one embodiment, the resultant novel polymer mixture is transparent or translucent. In this case the transparency, determined to ASTM D 1003, should preferably be above 50% and in particular above 80%. The difference between the refractive indices of the matrix component and rubber component here is preferably less than 0.2, particularly preferably less than 0.1. Transparent polymer mixtures are suitable as packaging material, for example.

The novel polymer mixtures have an excellent property profile for many applications. The novel polymer mixtures and, respectively, the moldings obtainable from these have very good mechanical properties, in particular very good impact strength together with very good heat resistance, and also good scratch resistance, good chemical resistance and good surface quality. The novel polymer mixtures also have consistently high stiffness even at high proportions of rubber, e.g. above 50% by weight of rubber, based on the total weight of the polymer mixture and this stiffness generally does not reduce again until the glass transition temperature of component A) has been reached. The polymer mixtures therefore retain very high storage moduli until just below the softening point of component A). Another advantage is the high thermal stability of the novel polymer mixtures. Even when subjected to prolonged exposure to high temperature, the novel polymer mixtures retain their good mechanical properties. The component B) present in the polymer mixture usually has a glass transition temperature below 0° C., preferably below −20° C. and particularly preferably below −30° C. Finally, the novel polymer mixtures are easy to obtain, even on an industrial scale. This also applies to the starting polymers used.

The examples below describe the invention in more detail, but do not limit the same.

### EXAMPLES

The thermal properties of the polymers were determined by Differential Scanning Calorimetry (DSC) (determination of glass transition temperature T_{g}) or Differential Thermogravimetry (DTG) (determination of thermal stability, the DTG peak observed under nitrogen being given). The heating rate for non-isothermal studies by DSC or DTG was 10 K/min unless otherwise stated.

The average molecular weights M_{w} and Mₙ were determined by gel permeation chromatography (GPC) with tetrahydrofuran as solvent, against standard polystyrene specimens.

The proportions given for the monomer units in the polymer chain were determined by ¹³C NMR in chloroform, and also be elemental analysis.

The storage modulus E′ was determined by DMA in Dual Cantilever Mode to DIN 53440 (flexural vibration test). The specimens were produced on a DACA mini injection molding machine and had dimensions 6×2×45 mm. The measurements were made on a Rheometrics model RSA II machine. The heating rate was 2° C./min, and testing took place on −100 to 150° C. The test frequency was 1 Hz with a deflection of 0.02%.

The softening point (Vicat B/50) was determined to DIN 53460.

The component A1) used was poly(styrene-co-acrylonitrile-co-SO₂) with the following composition: styrene 61.1 mol %, acrylonitrile 16.5 mol %, SO₂ 22.4 mol %; T_{g} 160.8° C., M_{w} 93800 g/mol, M_{w}/Mₙ 2.7, and the component A2) used was poly(styrene-co-acrylonitrile-co-SO₂) with the following composition: styrene 59.3 mol %, acrylonitrile 25.7 mol %, SO₂ 15 mol %; T_{g} 138° C., M_{w} 126800 g/mol, M_{w}/Mₙ 2.0.

The compound A3) used was poly(styrene-co-acrylonitrile) with the following composition: styrene 67 mol %, acrylonitrile 33 mol %; T_{g} 111° C., M_{w} 97800 g/mol, M_{w}/Mₙ 2.5.

The following rubbers were used as component B):

B1: Blendex® WX 270 (General Electric Specialties), a particulate polyolefin rubber, grafted with poly(styrene-co-acrylonitrile) (weight ratio of graft core to graft shell: 70/30), average particle size from 0.3 to 1.3 μm;

B2: Blendex® 338 (General Electric Specialties), a particulate polybutadiene rubber, grafted with poly(styrene-co-acrylonitrile) (weight ratio of graft core to graft shell: 70/30), average particle size 0.3 μm;

B3: Metablen®C 301 (Elf Atochem), a particulate poly(styrene-co-butadiene) rubber, grafted with methyl methacrylate and styrene, average particle size 0.1 μm;

B4: Graft copolymer with a crosslinked polybutyl acrylate core and with a grafted-on shell made from poly(styrene-co-acrylonitrile) (60/40), average particle size 0.1 μm;

B5: Graft copolymer with a crosslinked polybutyl acrylate core and a grafted-on shell made from polystyrene and poly(styrene-co-acrylonitrile) (60/40), average particle size 0.5 μm;

B6: Graft copolymer with polybutadiene core and with a grafted-on poly(styrene-co-acrylonitrile) shell (weight ratio of graft core to graft shell: 62/38).

To prepare the polymer mixtures, the individual components were premixed dry, and mixed in the melt in a DACA mini compounder (fill: 5.0 g) at 220° C. for a period of 2 min (100 rpm). The polymer mixture was extruded, cooled, pelletized and dried. Table 1: Glass transition temperatures of the polymer mixtures (1:1, % by weight/% by weight)

| | | Hard phase | | Soft phase |
|---|---|---|---|---|
| Polymer | Hard phase | comp. B) | Soft phase | comp. B) |
| mixture | comp. B)^{a)} | in blend | comp. B)^{a)} | in blend |
| A1 | — | — | — | — |
| A1/B1 | 108 | — | −35 | −42 |
| A1/B2 | 109 | — | −78 | −85 |
| A1/B3 | 93 | 94 | −45 | −49 |
| A1/B4 | 115 | — | −38 | −41 |
| A1/B5 | 114 | — | −38 | −44 |

^{a)}Determined on component B) in isolation

Table 2 below gives the storage moduli of the polymer mixtures as a function of various rubber components.

TABLE 2
Storage moduli of polymer mixtures (1:1; % by weight/%
by weight)

| | Modulus | | Modulus | |
|---|---|---|---|---|
| | (23° C.)^{a)} | | (100° C.)^{a)} | Modulus of |
| | [×10⁸] | Modulus of | [×10⁸] | blend |
| Polymer | Rubber | blend (23° C.) | Rubber | (100° C.) |
| mixture | component | [×10⁸] | component | [×10⁸] |
| A1 | 40.2 | — | 34.2 | — |
| A1/B1 | 3.8 | 22.1 | 1.0 | 17.9 |
| A1/B2 | 4.5 | 21.4 | 1.2 | 17.4 |
| A1/B3 | 5.0 | 20.9 | — | 14.8 |
| A1/B4 | 5.8 | 19.9 | 1.8 | 15.2 |
| A1/B5 | 6.2 | 20.6 | 2.1 | 16.5 |

^{a)}Determined on component B) in isolation except in the case of the pure component A1)

Table 3 below shows Vicat B/50 heat distortion temperatures.

TABLE 3
Vicat B/50

| Experiment^{a)} | Blend^{c)} | Vicat temp. [° C.] |
|---|---|---|
| 1 | A2/B5 | 122.6 |
| 2 | A2/B6 | 121.3 |
| 3^{b)} | A3/B5 | 104.3 |
| 4^{b)} | A3/B6 | 103.7 |

The blends were prepared by mixing the individual components dry, followed by processing in a Haake PTW6 extruder at 180° C. at 200 rpm with a throughput of 0.5 kg/h. Pressings were molded from the resultant pellets at 190° C.

### Comparative Experiment

Blend composition: 76.9% by weight of A2 and, respectively, A3, 23.0% by weight of B5 and, respectively, B6, and 0.1% by weight of octadecyl 3-(3,5-di-tert-butyl-4-hydroxyphenyl)propionate (Irganox® 1076).

We claim:

1. An impact-modified thermoplastic polymer mixture comprising copolymers (component A) formed from sulfur dioxide (a₁), from vinyl aromatic compounds (a₂), from unsaturated polar compounds (a31) selected from the group consisting of compounds of the formula (I) 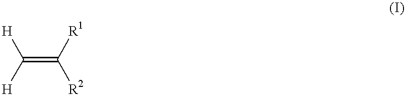
where R¹ is hydrogen or methyl and R² is CN, CHO or COOR³, where R³ is hydrogen or C₁-C₂₀-alkyl, and/or from cyclic olefins having non-conjungated double bonds (a₃₂) or from non-polar acyclic aliphatic olefins (a₃₃) and comprising at least one polymeric rubber compound with an elastomeric property profile (component B), and also, if desired, thermoplastic polymers (component C) and processing aids, colorants, stabilizers, antioxidants or reinforcing materials (component D).

2. A thermoplastic polymer mixture as claimed in claim 1, wherein component A) is a ternary copolymer made from sulfur dioxide, from a vinyl aromatic compound and from a polar olefinically unsaturated compound (I).

3. A thermoplastic polymer mixture as claimed in claim 1 or 2, wherein component A) is poly(styrene-co-acrylonitrile-co-SO₂).

4. A thermoplastic polymer mixture as claimed in claim 2 or 3, wherein from 0.1 to 50 mol % of SO₂, from 1 to 99 mol % of vinyl aromatic compound and from 0.9 to 70 mol % of polar olefinically unsaturated compound are present in component A).

5. A thermoplastic polymer mixture as claimed in any of claims 1 to 4, wherein component C) is polyalkyl methacrylates, polystyrene, polyamides, polycarbonates, polyesters, polysulfones, polyurethanes, polyvinyl chloride, polyolefins, polyphenylene ethers, styrene (co)polymers, impact-modified styrene (co)polymers, imidated or non-imidated copolymers made from styrene and maleic anhydride (MA), polymethacrylimides, polyacetals, polyacrylonitrile or any desired mixture of the abovementioned compounds.

6. A thermoplastic polymer mixture as claimed in any of claims 1 to 5, wherein component C) is styrene (co)polymers, rubber-modified styrene (co)polymers or a mixture of these.

7. A thermoplastic polymer mixture as claimed in any of claims 1 to 6, wherein the proportion of
component A) is from 1 to 99% by weight,
component B) is from 1 to 99% by weight,
component C) is from 0 to 95% by weight, and
component D) is from 0 to 50% by weight,
based in each case on the total weight of the thermoplastic polymer mixture, where the total of the percentages by weight is always 100.

8. A thermoplastic polymer mixture as claimed in any of claims 1 to 6, wherein the proportion of
component A) is from 2 to 90% by weight,
component B) is from 2 to 80% by weight,
component C) is from 5 to 96% by weight, and
component D) is from 0 to 50% by weight,
based in each case on the total weight of the thermoplastic polymer mixture, where the total of the percentages by weight is always 100.

9. A process for preparing the polymer mixtures as claimed in any of claims 1 to 8, which comprises mixing components A) and B) and, if desired, components C) and D) without prior melting, and melting and homogenizing the resultant mixture during processing, or which comprises combining the components at an elevated temperature, with melting, and discharging and isolating the product.

10. The use of the polymer mixtures as claimed in any of claims 1 to 8 for producing fibers, films or moldings.
